(19) United States
(12) Patent Application Publication
(10) Pub. No.: US 2012/0292186 A1
(43) Pub. Date: Nov. 22, 2012

(54) Clarification of Tailing Ponds Using Electrophoresis

(76) Inventor: James Sidney Adamson, Calgary (CA)

(21) Appl. No.: 13/177,329

(22) Filed: Jul. 6, 2011

(30) Foreign Application Priority Data
May 17, 2011 (CA) 2741020

(51) Int. Cl. C02F 1/469

(52) U.S. Cl. 204/515

(57) ABSTRACT

A system for clarifying fine tailings in an aqueous suspension in oil sands tailing ponds uses electrophoresis to collect fine tailings on respective electrodes during application of a first electrical potential to the electrodes. The collected fine tailings can then be deposited from the electrodes to a collection area below the electrodes during application of a second electrical potential of opposing polarity. The first and second electrodes are continued to be alternately applied to the electrodes until the fluid is substantially clarified of fine tailings in suspension.

This application claims foreign priority benefits from Canadian Patent Application 2,741,020, filed May 17, 2011.

### FIELD OF THE INVENTION

The present invention relates to a system for clarifying fine tailings in an aqueous suspension in oil sands tailing ponds using electrophoresis, and more particularly the present invention relates to a method of settling fine tailings in an aqueous suspension by alternately applying first and second electrical potentials of opposing polarity to a plurality of electrodes suspending in the aqueous suspension.

### BACKGROUND

Tailings sand is one of the by-products of bitumen extraction. Bitumen is commonly separated from the ore using the Clark Hot Water Extraction process, which involves dispersion of the oil sands with water, steam, mechanical conditioning, and possible addition of caustic (NaOH), with the subsequent separation of bitumen from the sands. A significant by-product of the extraction process is the tailings stream, which contains water, unrecovered bitumen, a coarse sand fraction (>22 μm) and a fines fraction (<22 μm). The tailings stream is discharged into tailings/settling ponds, where the coarse solids segregate from the fines and are used to build the dykes that surround the tailing/settling ponds.

Tailings from the primary and secondary separation vessels are mainly solids and water with small residual quantities of bitumen. In addition, froth treatment tailings are pumped to the tailings ponds. In summary, the tailings are a warm aqueous suspension of sand, silt, clay residual bitumen.

Other than the screen oversize or reject taken from the tumblers which is placed back in the mined-out pit, all the other tailings are pumped to large tailings ponds, where the coarse solids settle out to form dykes and beaches while much of the fines and residual bitumen are carried into the pond as a thin slurry stream (about 8 wt % solids). Once the stream slows down, sedimentation of the elastic particles begins. Stokian and hindered settling take place leaving a largely clarified water layer at the surface of the pond. The clarified water is recovered and recycled as extraction process water.

The feed to the extraction plant also contains significant quantities of fine-grained materials, which remain in the slurry and are carried with the sand to the tailings pond. These fine-grained elastic materials (silts and clays) and the residual bitumen that sinks in the pond form an accreting layer which consolidates very slowly, or not at all. The resulting deposit of fine-grained sediment, water, and bitumen are known as ‘fine tailings” or “fine tails”.

Without the benefit of addition of large quantities of clean dilution water, recycle of water between the process and the tailings, tailings ponds in this closed loop have resulted in accumulation of fine clays and any dissolved inorganic ions in the tailings pond water system. Currently, millions of cubic meters of fine tailings are present in tailings ponds presenting a major environmental concern and necessitating development of environmentally acceptable disposal methods for the long term.

Over time, three zones have developed in a tailings pond. On top is about three meters of clear water which is continuously pumped back into the plant for reuse. Under the top layer is a transition zone of water and settling clay particles, about one meter thick. At the bottom is the fine tailings zone, a layer of clays, fine sand, bitumen, and water which increases in density with depth and is over 40 meters thick in some areas. In addition to the high concentration of solids, the water in the fine tailings contains a number of organic compounds such as naphthenic acids which are derived from the bitumen. Most of these organics are believed to be released from the oil sand during extraction, but can also be naturally occurring when oil is eroded by local streams. These compounds also contribute to the toxicity of the fine tailings.

It is generally thought that the extremely slow consolidation of the line tails is related to the dispersed nature of the fine and ultrafine particles as well as the ionic chemistry of the process Water.

The levels of dissolved organic carbon (DOC) reported in both the surface and pore waters from typical settling ponds are fairly low, considering the high oil content in the extraction stage and the potential for input of organics by on-site activities. Samples from some tailings ponds indicate that most of the DOC is contained in the <1000 MW fraction, which would include naphthenic acids as well as more volatile organic acids and phenols. In addition, the samples contained a small, but measurable amount of high molecular weight organics (5000-30000 MW).

Acid-extractable organics account for most of the acute toxicity in tailings pond recycle water and about 80% of toxicity in fine tails porewater. Up to 95% of the total acid fraction extractable from fine tails is composed of naphthenic acids, and these compounds are associated with most or all of the acute toxicity expressed by tailings pond water or fine tails porewater.

Naphthenic acids are predominantly carboxylic acids with a cyclic or polycylic alkane backbone (cyclopentene and cyclohexane) and aliphatic side chains of various lengths Naphthenic acids act as surfactants (compounds which modify the strength of surface attraction), and have both hydrophilic character as a result of the polar carboxyl group and hydrophobic character due to the nonpolar aliphatic end. While naphthenic acids are a natural component of bitumen, they are liberated from the bitumen during the extraction process. The addition of caustic soda accelerates the liberation of naphthenic acids into the process waters, where the acids are present as sodium salts (sodium naphthenates), rather than the parent acid, and the concentration of naphthenic acid in the wastewater slurry is correlated to the amount of sodium hydroxide added during extraction.

The addition of calcium compounds to tailings which contain natural surfactants (and hence are toxic), would be expected to remove the surfactants and make the tailings nontoxic. Experimentally, samples of tailings (toxic) treated with calcium sulfate (125 ppm) made the samples relatively nontoxic.

The data relating surfactant concentrations to toxicity, as discussed above, confirm that natural surfactants are responsible for the tailing toxicity.

The theory also suggests that compaction of Clark fine tailings is difficult due to electrostatic and steric effects. If the theory is correct, treatment with calcium compounds would be expected in removing the surfactants from the fine particles and make the tailings easy to compact.

The wet landscape option essentially leaves the fine tails as a fluid, which means that they are non-trafficable and require containment in geotechnically secure areas. The surface mining of the oil sands results in development of large mined-out pits, which may meet the criteria for areas to be used for long-term secure containment of fluid materials.

Containment within the mine pits would be below original grade and depths of more than 40 m of line tails are expected, with the surface areas of the lake(s) being determined by the accepted mine plan. During the period of fine tails transfer, further densification will occur (as a result of dewatering and consolidation), so that by the time a capping layer of water is applied, average solids content of the fine tails should be greater than 40%.

The fine tails would be capped with water over a period of several years. The source of the capping water would be determined by availability and limits set by ongoing research results and regulatory approvals. Potential sources include various combinations of one or all of the following: natural surface waters from local rivers or diffuse runoff, drainage waters from dry reclamation features (e.g., sand storage areas), and for process-affected waters.

In the settling basin, runoff water settles over time to produce a denser tine tails phase and a clarified water layer which is recycled to the extraction process. The maximum allowable solids concentration in the recycle water is 0.1 percent by weight, as determined by heat exchanger and extraction process requirements. The fine tails phase continues to densify until it forms mature fine tails which must ultimately be transferred to permanent storage below grade or otherwise reclaimed to meet environmental requirements.

Thus, there is considerable incentive to find ways of either reducing or eliminating the production of fine tails or of incorporating them in stable, solid deposits.

U.S. Pat. No. 4,623,442 by Ritter discloses an apparatus for continuously separating particulate solids from liquid suspensions. A clarifier is provided for simultaneously treating a plurality of bodies of liquid-solid suspension in a vertically stacked fashion, with the aim of separating the particulate solids from the liquid, by process steps involving a combination of electrophoresis and reverse osmosis. The clarifier comprises a conical shell which is mounted on a shaft for rotation. The shaft extends through the apex of the shell and is disposed at an upward angle, so that the base of the shell is tilted. A plurality of nested, spaced apart, truncated, conical bands are secured to the inner surface of the shell. The bands each carry an elongate anode electrode on the upper surface and an elongate cathode electrode on the lower surface. Thus there are formed a plurality of vertically stacked, endless, arcuate treatment chambers, with an elongate anode extending along the base and an elongate cathode electrode extending along the top of each chamber. A trough-like container closely surrounds the lower portion of the conical unit, to provide the inner wall for each treatment chamber. The upper portion of the conical unit overhangs the container. In use, fresh suspension is fed into one end of the portion of each chamber in the container. Substantially solids-free liquid is removed from the other end of each such chamber portion. The shell and bands are continuously rotating. Electric potential is applied to the electrodes to cause solids to deposit and dry on the anode. When the deposits are raised by the rotating bands, to overhang the container, the deposits drop free of the conical unit, for separate recovery.

U.S. Pat. No. 4,501,648, also by Ritter, discloses an Electrophoretic Process for Separating Aqueous Mineral Suspensions. An aqueous suspension of fine mineral solids, for example oil sand tailings sludge, is separated into separate solid and liquid components by first chemically conditioning the suspension with the addition of lime, and thereafter passing an electrical potential between electrodes submerged in the suspension. The electrical potential causes the solids to migrate toward, and deposit on, the positive of the electrodes. The lime pre-treatment allows the electrode deposit to dry, through electroosmosis, to render it sufficiently dry by disposal. The chemical conditioning step preferably includes adding a carbonate- or bicarbonate-forming reagent after the lime addition.

US Patent Application Publication No. US2007/0267355 by Jones et al discloses a Waste and Tailings Dewatering Treatment System and Method. An apparatus and method are described for reducing the liquid content of a material comprising a particulate/liquid dispersion or suspension, in particular comprising a dispersion or suspension of inorganic particles being a byproduct of mining, manufacturing or other industrial processes. The apparatus comprising a receiving zone to contain the material, at least one pair of electrodes spaced apart within the receiving zone, means to apply potential difference thereacross and hence across the material in use to drive electrokinetic dewatering, and drainage means to enable removal of water, wherein at least one of the electrodes comprises a textile or other synthetic material at least in part associated with a conductor so as to constitute where so associated a conducting electrokinetic textile or other synthetic material. The method makes use of the apparatus, in situ or at a remote site either as a batch or continuous process.

### SUMMARY OF THE INVENTION

According to one aspect of the invention there is provided a method of settling fine tailings in an aqueous suspension in a tailings settling basin, the method comprising:

suspending a first array comprising a plurality of first electrodes in the tailings settling basin;

suspending a second array comprising a plurality of second electrodes in the tailings settling basin; and

alternately applying to the electrodes a first electrical potential such that the first electrodes function as anodes and the second electrodes function as cathodes and a second electrical potential such that the first electrodes function as cathodes and the second electrodes function as anodes;

applying the first electrical potential for a first prescribed duration such that a portion of the fine tailings in the aqueous suspension which are negatively charged are collected on the first electrodes and such that fine tailings collected on the second electrodes during the application of the second electrical potential are deposited from the second electrodes to a collection area below the electrodes; and

applying the second electrical position for a second prescribed duration such that a portion of the fine tailings in the aqueous suspension which are negatively charged are collected on the second electrodes and such that fine tailings collected on the first electrodes during the application of the first electrical potential are deposited from the first electrodes to the collection area below the electrodes.

As described above, the present ponds are saturated by Bentonite fines which carry a negative charge and stand in the water as they repel each other causing it to remain in a milky state for long periods of time. The water cannot be reused in its' present state. The present process to remove these “fines” uses Electrolysis in a controlled manner to solve this problem and return the water to a clear useable state in a few hours. This process uses Electrolysis for the interchange of atoms and ions by the removal or addition of electrons from the external circuit.

The first and second electrical potentials are preferably applied such that the first and second prescribed durations are substantially equal.

Each first electrode is preferably suspended between respective ones of the second electrodes such that all of the electrodes are spaced apart from one another.

The application of the first electrical potential may be switched to application of the second electrical potential when the first electrodes are fully coated with fine tailings.

A collection member may be provided in the collection area below the electrodes so as to be arranged to collected fine tailings deposited from the electrodes thereon.

The method typically involves collecting bentonite fines on the first electrodes during application of the first electrical potential and collecting bentonite fines on the second electrodes during application of the second electrical potential.

In several preferred embodiments, the electrodes are buoyantly supported in the aqueous solution. In this instance, a battery may be buoyantly supported together with the electrodes to apply the first and second electrical potentials to the batteries.

A height of the electrodes relative to the aqueous suspension may be adjusted by adjusting a buoyancy of a supporting structure upon which the electrodes are supported.

In one embodiment all of the electrodes are supported on a common buoyant support structure which is buoyantly supported in the aqueous suspension.

The common buoyant structure may be connected to a positioning system adjacent to a body of fluid within which the electrodes are buoyantly supported such that the positioning system is arranged to displace the common buoyant support structure between a plurality of different treatment positions. The first electrical potential and the second electrical potential can be applied in sequence at each of the treatment positions. The positioning system may comprise a pair of winches on opposing sides of the common buoyant structure having respective winch cables connected to the common buoyant structure.

The common buoyant structure may also be supported on respective guide wheels arranged for rolling movement across a bottom of the body of fluid between the different treatment positions.

A collection member may also be supported on the common buoyant structure such that the collection member spans the collection area below the electrodes of the first and second arrays and such that the collection member is arranged to collect fines deposited from all of the electrodes of the first and second arrays.

In a further embodiment, each individual electrode may be individually buoyantly supported in the aqueous solution on a respective buoyant member.

In a further embodiment, a treatment basin may be located adjacent an oil sands tailing pond so as to be arranged to receive fine tailings in an aqueous solution from the tailing pond. In this instance the first and second arrays of electrodes are suspended in the treatment basin such that fine tailings collected on the electrodes are deposited from the electrodes in the collection area at a bottom of the treatment basin.

A track may span over the treatment basin and suspend the electrodes from a common carriage member supported for horizontal movement along the track. In this instance, the common carriage member can be displaced between a plurality of different treatment positions with the first electrical potential and the second electrical potential being applied in sequence at each of the treatment positions.

A port may be provided in communication between the treatment basin and the tailing pond such that the treatment basin is arranged to be gravity fed by the tailing pond. In this instance, a float valve may be located in the port which is arranged to close the port when a fluid level in the tailing pond falls below a prescribed lower limit.

Accordingly to another aspect of the present invention there is provided a method of settling fine particles in an aqueous suspension in a basin, the method comprising:

suspending a first array comprising a plurality of first electrodes in the basin;

suspending a second array comprising a plurality of second electrodes in the basin; and

alternately applying to the electrodes a first electrical potential such that the first electrodes function as anodes and the second electrodes function as cathodes and a second electrical potential such that the first electrodes function as cathodes and the second electrodes function as anodes;

applying the first electrical potential for a first prescribed duration such that a portion of the fine particles in the aqueous suspension which are negatively charged are collected on the first electrodes and such that fine particles collected on the second electrodes during the application of the second electrical potential are deposited from the second electrodes to a collection area below the electrodes; and

applying the second electrical position for a second prescribed duration such that a portion of the fine particles in the aqueous suspension which are negatively charged are collected on the second electrodes and such that fine particles collected on the first electrodes during the application of the first electrical potential are deposited from the first electrodes to the collection area below the electrodes.

Various embodiments of the invention will now be described in conjunction with the accompanying drawings in which:

### BRIEF DESCRIPTION OF THE DRAWINGS

FIG. 1 is a schematic view of a first embodiment of the tailing pond clarification system during application of the first electrical potential.

FIG. 2 is a schematic view of the first embodiment of the tailing pond clarification system during application of the second electrical potential.

FIG. 3 is a side elevational view of a second embodiment of the tailing pond clarification system.

FIG. 4 is a side elevational view of a third embodiment of the tailing pond clarification system.

FIG. 5 is a side elevational view of a fourth embodiment of the tailing pond clarification system.

FIG. 6 is a top plan view of the fourth embodiment of the tailing pond clarification system.

FIG. 7 is a side elevational view of a fifth embodiment of the tailing pond clarification system.

In the drawings like characters of reference indicate corresponding parts in the different figures.

### DETAILED DESCRIPTION

Referring to the accompanying figures there is illustrated a tailing ponds clarification system generally indicated by reference numeral 10. The system 10 relies on electrophoresis to provide a method of settling fine tailings in tailing ponds of the type used in the hot water extraction method of re-claiming oil from oil sands. The system permits settling of fine tailing such as bentonite fines or other types of fines commonly found in oil sands tailing ponds.

Although various embodiments of the system 10 are described an illustrated herein, the features in common with the various embodiments will first be described.

The system includes a first array comprising a plurality of first electrodes 12 and a second array comprising a plurality of second electrodes 14. Within each array, the electrodes are evenly spaced apart in perpendicular first and second horizontal directions such that the electrodes within each array comprise a substantially evenly spaced apart grid. The electrodes comprise vertical rods of conductive material suspended in the body of fluid of a tailing pond or treatment basin in which the body of fluid comprises an aqueous suspension of fine particles suspended in water. The first and second arrays are typically interspersed such that each first electrode is evenly spaced between corresponding second electrodes of the second array while each second electrode is similarly centrally located between adjacent ones of the electrodes of the first array.

A power source 16 provides power to the electrodes through a suitable controller 18 for applying either a first electrical potential or a second electrical potential across the first and second electrodes. The controller functions to apply the first and second electrical potentials alternately with one another. The electrical potential is applied in a plurality of cycles in sequence in which each full cycle comprises applying the first electrical potential for a first duration followed by applying the second electrical potential for a respective second duration.

Typically, the first electrical potential is applied for its respective first prescribed duration which may be in the order of 30 minutes as an example. The first electrical potential corresponds to applying a current to the electrodes such that the first electrodes of the first array collectively function as respective anodes while the second electrodes of the second array collectively function as cathodes. When applying the first electrical potential for 30 minutes for example, a suitable potential may comprise 14 volts of direct current at 30-40 milliamps when the first and second electrodes are spaced apart from one another by a spacing near 38 inches for example. Typically the first electrical potential is applied until negatively charged fines of bentonite substantially fully coat the first electrodes corresponding to a prescribed magnitude of collected fines having a prescribed thickness on the electrodes prior to switching to application of the second electrical potential.

The second electrical potential is applied at similar conditions to the first electrical potential such that the first and second durations are substantially equal. The second electrical potential is alternate in polarity to the first potential, however, such that the first electrodes, 12 in this instance function as respective cathodes while the second electrodes 14 function as respective anodes of the system. The second electrical potential is thus applied until the negative fines substantially fully coat the second electrodes while the negative fines collected previously on the first electrodes are repelled and encouraged to deposit and settle into a collection area 19 below the electrodes.

After each full cycle, a new cycle begins such that subsequent application of the first electrical potential of the next cycle similarly causes all of the previously collected negative fines on the second electrodes to be repelled and encouraged to settle in the collection area below the electrodes. During the first electrical potential being applied, positive fines are also attracted to the cathode to be subsequently repelled and encouraged to settle into the collection area during the second electrical potential. During the second electrical potential the positive fines are similarly collected on the first electrodes and are encouraged to settle from their previous collection on the second electrodes.

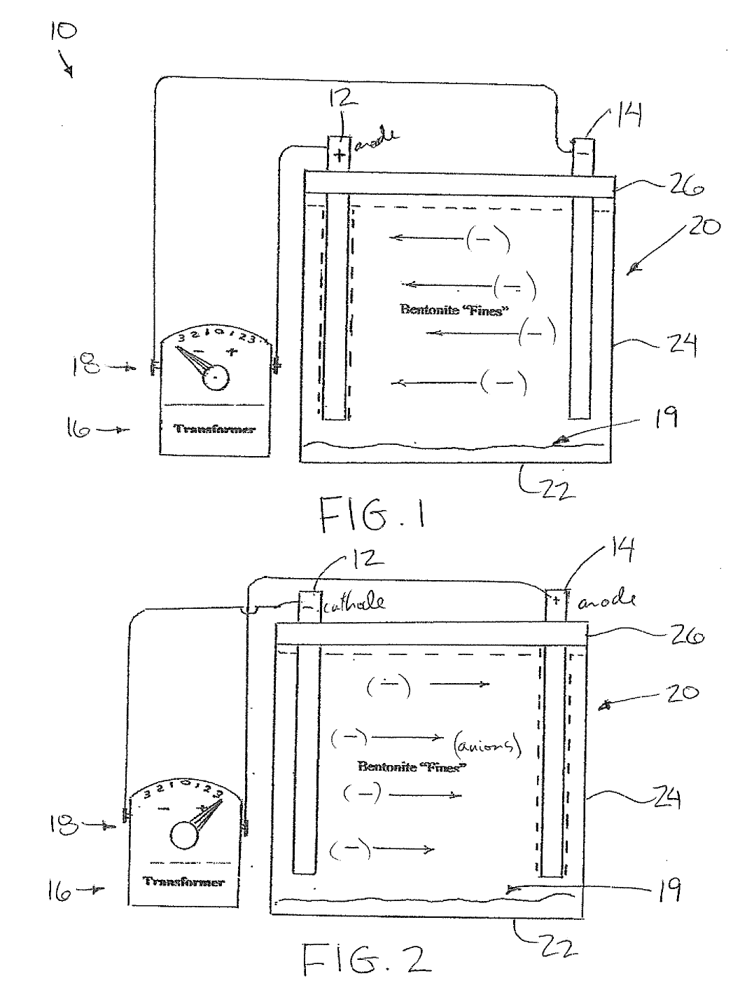

Turning now to the embodiments of FIGS. 1 and 2, a batch treatment tank 20 is illustrated in which the tank includes an enclosed bottom 22 and side walls in sealed connection therewith to contain an aqueous solution therein. An overhead structure 26 is provided for spanning across the top end of the side walls 24 to suspend the electrodes of the first and second arrays therefrom such that the bottom ends of the electrodes are spaced upwardly from the bottom end of the tank to define space for the collection area 19.

The bottom end of the tank may be provided with a sludge removal system comprising augers or shovels and the like for periodic removal of the settled fines collected as a sludge in the collection area at the bottom of the tank. In the illustrated embodiment, the first and second electrodes are supported along respective opposing sides of the treatment tank 20 to encourage a uniform migration of charged fines towards the respective anodes and cathodes during the application of the respective electrical potentials.

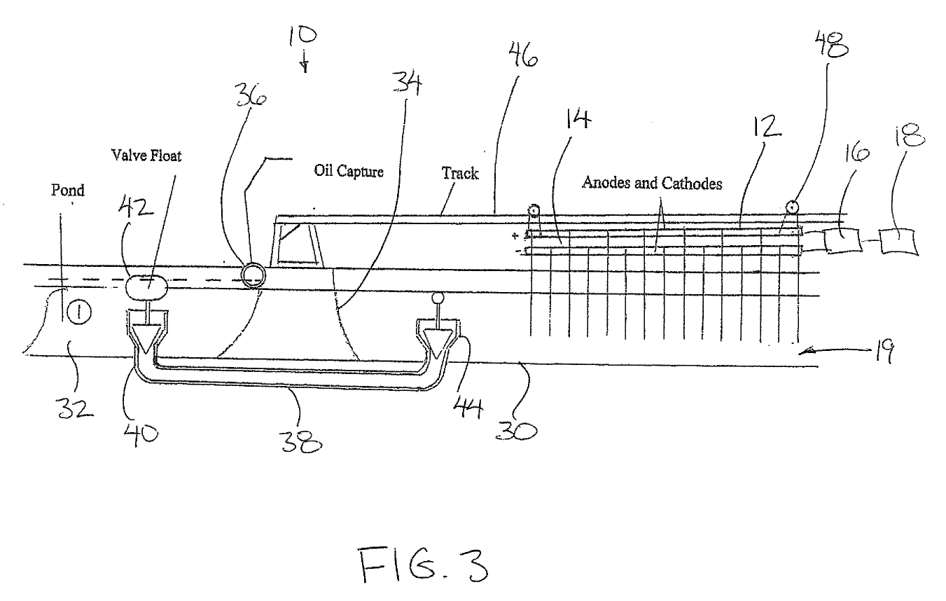

Turning now to FIG. 3, the system 10 in this instance comprises a basin 30 for location on site adjacent a conventional tailing pond 32. The system includes a barrier 34 which forms a divider between the basin 30 and the pond 32 to maintain separation of the fluids in the basin and the pond respectively.

A skimmer outlet 36 is located in proximity to the barrier adjacent the upper level of the fluid in the tailing pond 32 so as to capture any oil floating on the surface of the fluid in the settling pond by skimming the oil floating on the surface into the skimmer outlet 36.

The fluid in the form of fines in an aqueous suspension in water is communicated from the pond 32 to the treatment basin 30 through a suitable communicating port 38 which communicates across the barrier to communicate fluid from the pond to the basin by gravity and/or siphoning action. The port 38 includes an inlet 40 in communication with the fluid in the pond 32. The inlet is located at an intermediate height spaced above the bottom of the pond where fines may already be settled while being spaced below clarified capping water at the surface of the tailing pond 32. The inlet is thus aligned with the milky aqueous suspension layer of the pond 32. A float control 42 is located at the inlet 40 to control opening and closing of the inlet. In particular, the float is only open when the fluid level in the pond is sufficiently high that there is sufficient volume in the aqueous suspension layer for treatment.

The outlet 44 of the port 38 communicates with the treatment tank 20 at an area spaced above the bottom so as to be above the collection area 19 where fines are settled. The outlet is similarly located at an intermediate height so as to be below a clarified upper portion of the treatment basin. The outlet may also be provided with an appropriate float control or other suitable mechanical or electrically actuated valve mechanism such that the valve opens when the level in the basin falls below a prescribed lower limit for treatment while being arranged to close to prevent fluid rising above a prescribed upper limit for treatment. The valve at the outlet 44 may also be closed during application of the first and second electrical potentials when performing batch treatments of the fluid in the basin.

The electrodes in this instance are supported on a suitable overhead structure 46 comprising a track supported at opposing ends on opposing sides of the basin above the height of the barrier. A carriage 48 is supported for rolling movement along the track in which the carriage comprises a suitable frame for supporting all of the first and second electrodes of the first and second arrays respectively. All of the electrodes are thus supported for horizontal movement together along the track between opposing sides of the basin. Typically, the track comprises a rigid channel supported at opposing ends to be adjustable in height relative to the corresponding support structures to ensure that the electrodes are supported at the appropriate height relative to the fluid level in the treatment basin.

In use, the carriage typically remains stationary during application of a full cycle of alternating first and second electrical potentials being applied. After completing each full cycle, the carriage supporting the electrodes thereon may be horizontally displaced to a new position within the basin for application of another full cycle of first and second electrical potentials. The carriage may be displaced between a plurality of different treatment positions at evenly spaced positions along the track. In the instance of a continuous flow of fluid to be treated, clarified water rising to the top of the treatment basin may be continuously siphoned off while the carriage is repeatedly displaced between different treatment positions back and forth between opposing sides of the basin corresponding to opposing ends of the track. At each treatment position, the carriage remains stationary for a full cycle of application of the first and second electrical potentials.

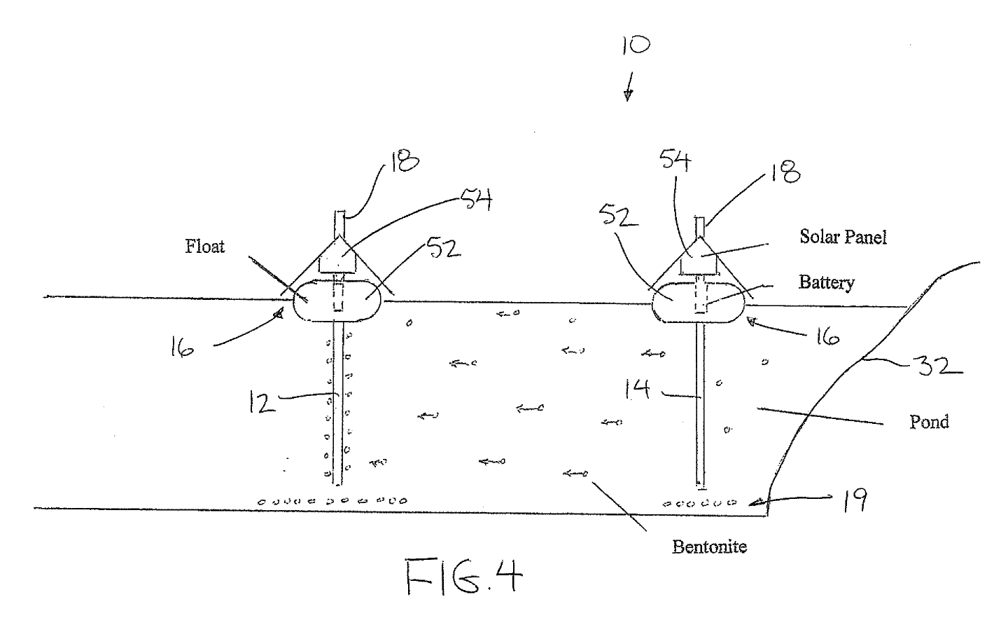

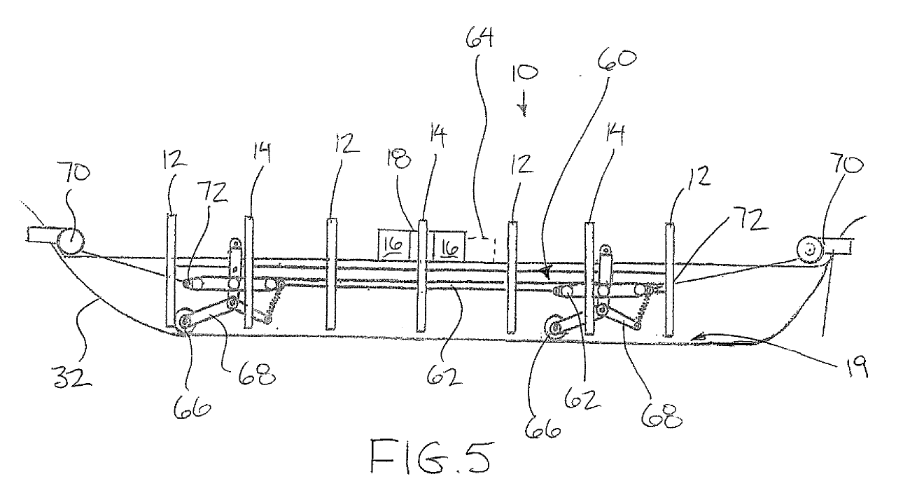

Turning now to FIG. 4, the electrodes in this instance are individually supported for floatation within the aqueous suspension by respective float members 50. Each float member supports the respective electrode to be suspended vertically therebelow in the fluid suspension. The float member 50 also supports the components of the power source which include a battery 52 and solar panels 54 supported at the top end of the floating unit so as to be supported above the fluid level within which the float member is buoyantly supported. A controller 18 is provided on each floating unit also supported by the respective float member 50 for controlling connection of the respective electrode to the battery for alternately being operated as an anode or a cathode.

The float members typically include respective anchors associated therewith such that each float member is tethered to a respective anchor to support the float members in respective arrays of first and second electrodes as described above. The controllers of the individual floating units all communicate with one another and with a master controller which determines which electrodes are designated as first electrodes and which electrodes are designated as second electrodes. The individual floating units of FIG. 4 are particularly suited for use in existing ponds due to the minimal infrastructure required for installation.

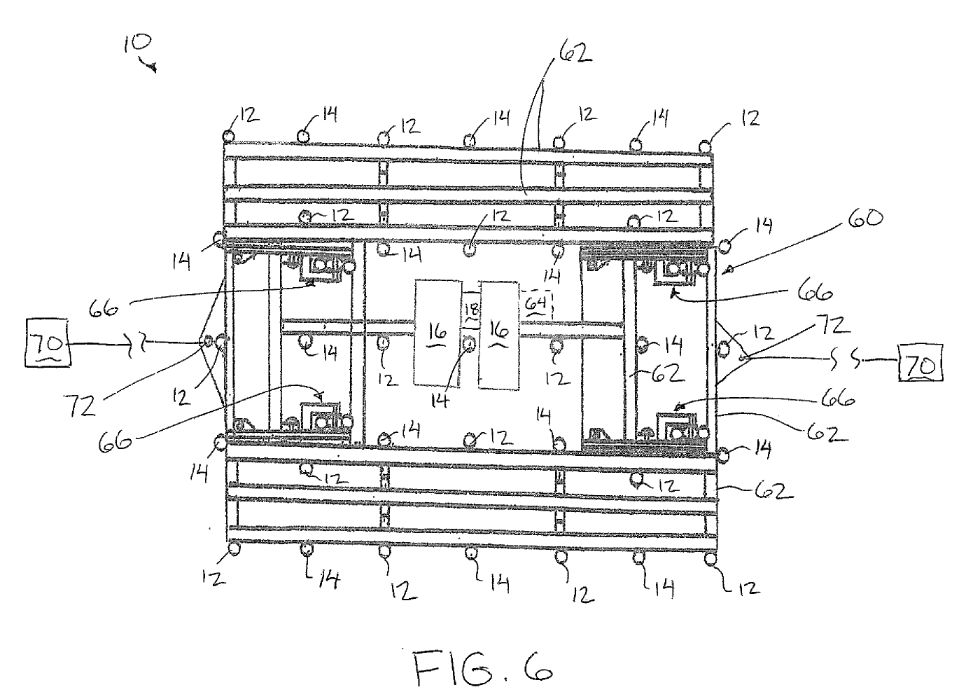

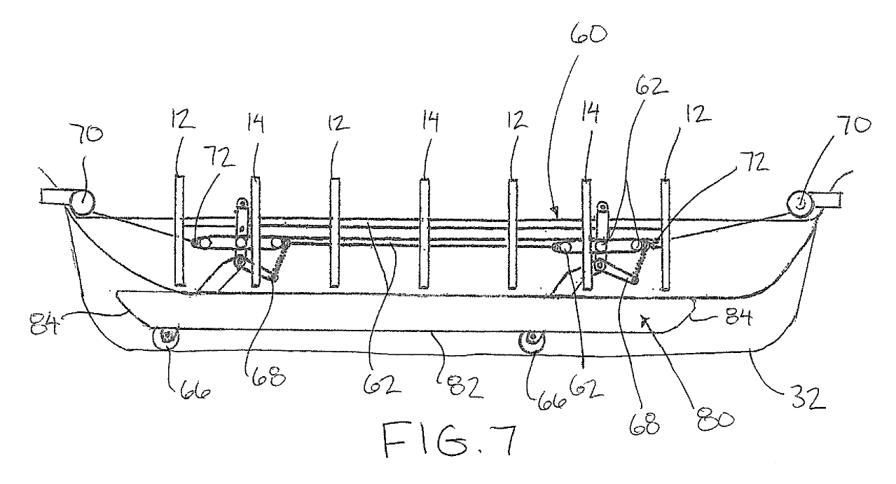

Turning now to the embodiment of FIGS. 5 and 6, the first and second arrays in this instance are supported for floating together on a common raft structure 60. The raft structure 60 comprises a hollow tubular frame comprised of a plurality of interconnected hollow tubular members 62 which are capped so as to provide buoyancy to the structure. The hollow interior of the tubular members are all interconnected to communicate with one another as well as being connected to a buoyancy control 64 which controls the amount of water or air permitted in the tubes for controlling the buoyancy thereof.

The buoyancy control 64 includes an air vent with an appropriate pump for pumping air in or venting air out of the tubes as well as a water port with a respective pump controlling the amount of water pumped into or out of the tubes. The buoyancy control thus controls the height of the structure 60 suspended within the water as well as the height of the electrodes suspended thereon. In normal operation, the raft structure is supported adjacent the top of the fluid in the pond with the electrodes suspended substantially fully below the fluid level. In some instances, it is desirable to protect the structure from adverse weather conditions by purposely flooding the tubes to allow the entirety of the structure to be submerged within the pond for protection from the weather.

In general it is desired to set the height of the electrodes to remain spaced above the bottom of the pond to provide for a collection area where the settled fines may be collected. To provide greater height control and further prevent the electrodes from contacting the bottom of the pond, a set of guide wheels 66 are provided at opposing ends and in association with opposing sides of the raft structure. Each guide wheel 66 is supported on a respective suspension arm 68 including a spring permitting the guide wheel to contact the bottom of the settling pond and carry some weight of the raft structure. The suspension includes a lower limit which prevents the structure from being suspended below a lower limit corresponding to the bottom ends of the electrodes contacting the bottom of the pond.

The raft structure 60 is also used to support the power source 16 in the form of batteries which may receive power from cabling connected to shore or from a solar array also buoyantly suspended on the structure of the electrodes as described in the previous embodiments. A controller is also associated with the battery for controlling operation of the first and second electrodes between application of a first electrical potential and application of the second electrical potential.

A position control is provided for permitting the raft structure 60 to be displaced between a plurality of horizontally spaced apart treatment positions where a full cycle of electrical potentials is applied at each treatment position similarly to the embodiment of FIG. 3 described above. The positioning system comprises a cable winch 70 supported at each of two opposing sides of the pond for winding a cable thereon in which the two cables are connected to longitudinally opposed ends 72 of the raft when the guide wheels are supported for rolling movement in the longitudinal direction between the opposing ends 72. By winding one winch and allowing the other winch to unwind, the raft structure is effectively displaced towards the winding winch. Operating the other winch in turn causes the raft structure to be returned towards that other winch.

Turning now to FIG. 7, the electrodes are similarly supported on a raft structure 60 as in the previous embodiment, however, in this instance, the raft structure also supports a collection member 80. The collection member generally comprises a tray which spans the full horizontal area below the first and second arrays of electrodes. The collection member is suspended by the raft structure within the collection area below the bottom ends of the electrode and includes a generally horizontal bottom wall 82 with side walls 84 extending upwardly from the periphery thereof for containing settled fines thereon. The collection member is moveable together with the raft between the different treatment positions while also being arranged for ready removal from the raft structure and from the pond to allow disposal of the collected fines as desired.

In all embodiments, these structures supporting the arrays may be provided with an additive dispenser for adding appropriate treatment additives into the aqueous suspension therebelow in which the additives are used to assist in the precipitation of the fines or to assist in neutralizing acids and the like within the suspension. The additives may also be used to encourage appropriate chemical reactions to cause the fines to be more readily charged for attraction to the anode or cathode respectively.

As described herein, a liquid containing mobile ions (Tailing Ponds) in a water solvent, activated by an electrical potential is applied to two electrodes (or as required) immersed in the electrolyte. Each electrode attracts ions that are of the opposite charge, negative charged ions (anions) move toward the positive anode, while the positively charged ions (Cations) move towards the electrons providing (negative) cathodes. At the electrodes electrons are absorbed or released by the atoms and ions. The atoms that gain or lose electrons to become charged ions pass into the electrolyte. The ions that gain or lose electrons to become uncharged atoms separate from the electrolytes. The formations of uncharged atoms from ions is called discharging.

The energy required to cause the ions to migrate to the electrodes, and the energy to cause the change in ionic state is provided by the external source of electrical potential.

This energy and its' application is one of the keys to this process to make it a workable and continuous process.

The negative “fines” move to the positive anode in such quantities that along with the gas (bubbles) created, polarize the positive pole in a short time.

This process requires the switching of the poles negative to positive and positive to negative at set intervals to alleviate this problem. One example uses half hour intervals, and continues at that interval change for 2 or 3 hours till the water was clear. Any other interval that may be necessary or required at any particular location. When this switching of poles is done the load of negative “fines” on the positive pole falls off when it is switched to become the negative cathode pole. The old negative pole now becomes the positive pole and is soon covered with the “fines” to be dropped off at the next “switch” interval. All of the “fines” go to the bottom of the pond and stay there, and they will return to the bottom if disturbed. The use of this process is novel for the oil sand “fines” removal.

As further described herein, when the negative flow is to the anode and the negative “tails” cover the anode like a sleeve about ⅛ of an inch thick and polarize or stop the flow of any further negative “tails”, then a reverse of polarity reverses the flow. The positive anode becomes the negative cathode. When this switching takes place the hydrogen bubbles start to rapidly gather under the “tails” sleeve and their expansion completely releases the sleeve and the “tails” fall off the “old” anode which has now become a cathode. The negative “tails” now gather on the “new” anode.

The hydrogen bubbles which expand the “tails” sleeve so that it falls off are the key to the release of the sleeve of “tails” so that the process is continuous.

To make it simple, here is what is happening in the tailing “fines” removal process. Electrolysis of water breaks water down into hydrogen and oxygen. The present invention piggybacks the tailings removal process to the positive conditions created by this electrolysis. The positive effect is not only producing oxygen gas, but is also attracting all the negative charged particles of Bentonite clays to the positive pole. Because there are so many negative tailing “fines” in the water that are attracted to the positive pole it is quickly covered with these “fines” and it is necessary to reverse the polarity to make these “fines” fall off and sink to the bottom of the pond. By reversing the polarity and making the negative pole now a positive pole the process can be continuous.

Some of the oil sands processes require a method of eliminating the clay and bentonite “fines” from the water in the ponds that are used in the process of recovering the oil. The clay and the bentonite fines left in the water have a negative effect and repel each other, and make the water from the process milky. The water cannot be discharged into the rivers, or reused in this milky state. These ponds can take months or years to settle out. The large ponds continue to multiply and are not the answer to the problem.

The process described herein can make the milky water clear in a matter of a few hours, instead of months and years that it takes now. The negative effect of the particles of bentonite can be neutralized by applying a current of electricity to the anodes and cathodes for from two to four hours, after which time the solution becomes perfectly clear, and the particles are all at the bottom of the test container having lost their negative effect.

This system works at controlled voltages, polarities and timing. This method has been tested many times and has produced clear water every test. These tests have been done on a small scale, and should work on a large scale which would allow most of the water to be reused at once when treated. The use of water from other sources would be greatly reduced, and settling ponds may not be necessary.

This process completely cancels the negative effects of the particles that cause them to stand in the solution and does not allow the water to return to the milky state.

As noted above, this is a process to remove the “fines” from the water which has been used in the plant to remove the oil from the oil sands. This process uses the electrolysis of water to create the condition where the anions and cations under the influence of an external current move in a solution to the anode and cathode to break water down to its' elements (namely hydrogen and oxygen). This system uses this condition and this negative attraction to the anode to also attract the negative “fines”, of Bentonite clay to the anode. However the flow of the negative clays is so great that the anode is completely covered and polarized in a short time. To eliminate this condition the process switches the polarity of the two poles from negative to positive and positive to negative. In doing so the anode which was covered with negative “fines” now releases these “fines” as it becomes the positive cathode. Now the positive cathode is a negative anode and it begins to become covered with the negative clay “fines”. By the periodic reversal of the DC current to the anode and cathode every half hour (or as required) the process is continuous. No mechanical or physical intervention is needed other than a switch to make this change of polarity. There are no poles to clean and all the “fines” and jell go to the bottom of the pond.

This process could be used in the plant or in the ponds. The raft structure embodiment described above has a number of Anodes-Cathodes and the one shown has a length of 24 feet and a width of 16 feet and has a large battery pack that is adequate for a 25 hour operation. Five of these units—side by side with a 4 foot spacing between them would clean an area 100 feet wide and 200 feet long to a depth of 10 feet in 24 hours. The frame is in the illustrated embodiment is made of sealed 4 inch PVC plastic pipe which floats on the ponds. The spring loaded wheels engage the pond bottom to keep the anodes off the bottom of the pond. The whole arrangement follows a cable stretched across the pond and it stays at each 25 foot interval for 3 or 4 hours and then it moves on to the next 24 foot interval to process it and remove all the “fines” leaving the water crystal clear and ready to be used by the plant again and again. The frame being air tight can be filled with water as required in windy adverse conditions and the water removed by a compressed air tank if necessary. The cable can be moved to another location on the pond by tracked vehicles, one on at each end of the pond to keep the cable taut.

The separate float unit embodiment is powered by solar Panels and a battery pack and could be used on a similar cable arrangement to process the water in smaller ponds.

The other embodiment could be used at the plant where the water and the sludge are dumped on a sloping bank and the water would run down to a pond where it would be processed at the same location however the sludge would have to be removed in a continuous way.

This system would remove the “fines” from the mix and neutralize their negative repulsion. The “fines” and the gels which form on the positive anodes will fall to the bottom of the pond or be captured by a container hung below the anode-cathode raft to catch the “fines” so they can have their naphthenic acid content (80%) neutralized, before being discharged to the bottom of the pond.

When the tailings (negative) repulsive effect is removed from the solution by the anode, the trashy surface layer loses some of its' negative support and more readily sinks to the bottom of the pond. All the above is possible because of the periodic reversing of the anode and cathode poles which allows the positive anode to attract and capture the “fine-tails” and at the reversing of the polarity to release them in a neutered state to the bottom of the pond, or the container beneath the anode-cathode raft arrangement.

Because the naphthenic acids are toxic to fish and cause corrosion in pipe lines and boiler tubes and are found in the “fines’, a container under the anode and cathodes captures the “fines” in the raft arrangement so they can be treated with a base and neutralized before being returned to the bottom of the ponds.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method of settling fine tailings in an aqueous suspension in a tailings settling basin, the method comprising:
suspending a first array comprising a plurality of first electrodes in the tailings settling basin;
suspending a second array comprising a plurality of second electrodes in the tailings settling basin; and
alternately applying to the electrodes a first electrical potential such that the first electrodes function as anodes and the second electrodes function as cathodes and a second electrical potential such that the first electrodes function as cathodes and the second electrodes function as anodes;
applying the first electrical potential for a first prescribed duration such that a portion of the fine tailings in the aqueous suspension which are negatively charged are collected on the first electrodes and such that fine tailings collected on the second electrodes during the application of the second electrical potential are deposited from the second electrodes to a collection area below the electrodes; and
applying the second electrical position for a second prescribed duration such that a portion of the fine tailings in the aqueous suspension which are negatively charged are collected on the second electrodes and such that fine tailings collected on the first electrodes during the application of the first electrical potential are deposited from the first electrodes to the collection area below the electrodes.

2. The method according to claim 1 including applying the first and second electrical potentials such that the first and second prescribed durations are substantially equal.

3. The method according to claim 1 including suspending each first electrode between respective ones of the second electrodes such that all of the electrodes are spaced apart from one another.

4. The method according to claim 1 including switching application of the first electrical potential to application of the second electrical potential when the first electrodes are fully coated with fine tailings.

5. The method according to claim 1 including providing a collection member in the collection area below the electrodes which is arranged to collected fine tailings deposited from the electrodes thereon.

6. The method according to claim 1 including collecting bentonite fines on the first electrodes during application of the first electrical potential and collecting bentonite fines on the second electrodes during application of the second electrical potential.

7. The method according to claim 1 including buoyantly supporting the electrodes in the aqueous solution.

8. The method according to claim 7 including buoyantly supporting a battery together with the electrodes and using the battery to apply the first and second electrical potentials to the batteries.

9. The method according to claim 7 including adjusting a height of the electrodes relative to the aqueous suspension by adjusting a buoyancy of a supporting structure upon which the electrodes are supported.

10. The method according to claim 1 including buoyantly supporting all of the electrodes on a common buoyant support structure which is buoyantly supported in the aqueous suspension.

11. The method according to claim 10 including connecting the common buoyant structure to a positioning system adjacent to a body of fluid within which the electrodes are buoyantly supported, operating the positioning system to displace the common buoyant support structure between a plurality of different treatment positions, and applying the first electrical potential and the second electrical potential in sequence at each of the treatment positions.

12. The method according to claim 11 wherein the positioning system comprises a pair of winches on opposing sides of the common buoyant structure having respective winch cables connected to the common buoyant structure.

13. The method according to claim 11 including supporting the common buoyant structure on respective guide wheels arranged for rolling movement across a bottom of the body of fluid between the different treatment positions.

14. The method according to claim 10 including supporting a collection member on the common buoyant structure such that the collection member spans the collection area below the electrodes of the first and second arrays and such that the collection member is arranged to collect fines deposited from all of the electrodes of the first and second arrays.

15. The method according to claim 1 including buoyantly supporting each individual electrode in the aqueous solution on a respective buoyant member.

16. The method according to claim 1 including providing a treatment basin adjacent an oil sands tailing pond which is arranged to receive fine tailings in an aqueous solution from the tailing pond and suspending the first and second arrays of electrodes in the treatment basin such that fine tailings collected on the electrodes are deposited from the electrodes in the collection area at a bottom of the treatment basin.

17. The method according to claim 16 including supporting a track spanning over the treatment basin and suspending the electrodes from a common carriage member supported for horizontal movement along the track.

18. The method according to claim 17 including displacing the common carriage member between a plurality of different treatment positions and applying the first electrical potential and the second electrical potential in sequence at each of the treatment positions.

19. The method according to claim 16 including providing a port in communication between the treatment basin and the tailing pond such that the treatment basin is arranged to be gravity fed by the tailing pond.

20. The method according to claim 19 including providing a float valve in the port which is arranged to close the port when a fluid level in the tailing pond falls below a prescribed lower limit.

21. A method of settling fine particles in an aqueous suspension in a basin, the method comprising:
suspending a first array comprising a plurality of first electrodes in the basin;
suspending a second array comprising a plurality of second electrodes in the basin; and
alternately applying to the electrodes a first electrical potential such that the first electrodes function as anodes and the second electrodes function as cathodes and a second electrical potential such that the first electrodes function as cathodes and the second electrodes function as anodes;
applying the first electrical potential for a first prescribed duration such that a portion of the fine particles in the aqueous suspension which are negatively charged are collected on the first electrodes and such that fine particles collected on the second electrodes during the application of the second electrical potential are deposited from the second electrodes to a collection area below the electrodes; and
applying the second electrical position for a second prescribed duration such that a portion of the fine particles in the aqueous suspension which are negatively charged are collected on the second electrodes and such that fine particles collected on the first electrodes during the application of the first electrical potential are deposited from the first electrodes to the collection area below the electrodes.
